(19) United States
(12) Patent Application Publication
(10) Pub. No.: US 2013/0171400 A1
(43) Pub. Date: Jul. 4, 2013

(54) FILM ASSEMBLY AND METHOD FOR ATTACHING THE SAME

(71) Applicant: Yu Ping Philip LIN, Taipei (TW)

(72) Inventor: Yu Ping Philip LIN, Taipei (TW)

(21) Appl. No.: 13/567,470

(22) Filed: Aug. 6, 2012

(30) Foreign Application Priority Data
Dec. 29, 2011 (TW) 100149597

(51) Int. Cl. B32B 3/04; C09J 7/02; B32B 7/06; B32B 38/10; B32B 7/12

(52) U.S. Cl. 428/41.8; 156/247; 428/58

(57) ABSTRACT

A film assembly comprises an application sheet, and an inner release film comprises a first film portion, a second film portion and a pull portion. The first film portion covers an inner surface of the application sheet and is easily detachable. The second film portion forms one piece with the first film portion at a connection edge and folded thereunder. The pull portion is formed at the second film portion and protrudes out from a first edge of the first film portion. The pull portion is pulled along a pull direction away from the connection edge while the second film portion contacts the surface of the article to pull the second film portion in tandem, causing the first film portion to detach from the inner surface of the application sheet, such that the inner surface is attached to the surface of the article without attracting undesired substances.

### FIELD OF THE INVENTION

The present invention is related to a film assembly, particularly to a film assembly for easy attachment to a surface of an article.

### BACKGROUND OF THE INVENTION

Many users attach a film to the surface of an article so as to prevent the surface from being scratched or in order to apply some effect to that surface. For example, users often apply protective films or optical films with special optical properties to the screens of electronic devices. Users may also apply thermal insulation films, or anti-UV films to car windows or house windows. Even during various bonding processes, hard substrates are attached to the surface of an article, such as attaching a glass plate to a panel.

As seen in FIG. 1, a conventional film assembly 1 usually comprises an application sheet 11 that is to be attached to a surface 20 of an article 2, an inner release film 13 covering an inner surface of the application sheet 11, and an outer release film 15 covering an outer surface of the application sheet 11.

During the application, the user must first peel back at least a portion of the inner release film 13 near an edge 10 of the application sheet 11 from the inner surface of the application sheet 11 to expose a portion of the inner surface of the application sheet 11 so that the user can roughly align the edge 10 with a predetermined alignment line 21 of the article 2 and attach the exposed portion of the inner surface of the application sheet 11 to the surface 20 of the article 2. Then, after peeling off the entire inner release film 13 from the inner surface of the application sheet 11, the entire inner surface of the application sheet 11 is attached to the surface 20 of the article 2. Finally, the user can remove the outer release film 15 from the outer surface of the application sheet 11 to complete the attachment process of the application sheet 11.

However, without the help of special tools, it is difficult for the user to accurately attach and align the application sheet 11 to a predetermined location of attachment on the surface 20 of the article 2 during the application. Thus, the user often has to remove the application sheet 11 and reattach and realign the application sheet 11 to the predetermined location of attachment on the surface 20 of the article 2 again and again. As a result, the application process for this kind of film assembly 1 is inconvenient for the user.

In addition, normally the process of attaching the application sheet 11 to the surface 20 of an article 2 is not conducted in a dust free environment, and therefore during the process of reattaching and realigning the application sheet 11 to the predetermined location of attachment on the surface 20 of the article 2, the adhesive inner surface of the application sheet 11 becomes susceptible to undesired substances, such as dust or filth on the user's hand. Undesired substances between the application sheet 11 and the surface 20 of the article 2 will then cause the application sheet 11 to fail to attach completely onto the surface 20 of the article 2, affecting the appearance of the article.

Please see FIG. 2A, which shows another film assembly 9 that is attached to the surface 20 of the article 2. The film assembly 9 comprises an application sheet 91, two first inner release films 92 placed side by side, a first adhesive layer 93 between the application sheet 91 and the first inner release films 92, second adhesive layers 94 arranged on inner surfaces of the first inner release films 92, and a second inner release film 95 arranged on inner surfaces of the second adhesive layers 94. To use the film assembly 9, the first step is to remove the second inner release film 95 from the second adhesive layers 94 and then the second adhesive layers 94 of the film assembly 9 are attached to the surface 20 of the article 2, as shown in FIG. 2B. The second step is to bend downward and remove one of the first inner release films 92 from the center, as shown in FIG. 2C. The third step is to attach a portion of the first adhesive layer 93 that is exposed after removing the first inner release film 92, to the surface 20 of the article 2, as shown in FIG. 2D. The fourth step is to bend and remove the remaining one of the first inner release films 92, as shown in FIG. 2E. Finally, the last step is to attach the first adhesive layer 93 completely onto the surface 20 of the article 2 so that the application sheet 91 is attached to the surface 20 of the article 2, as shown in FIG. 2F.

Even though the film assembly 9 can circumvent the process of reattaching and realigning the first adhesive layer 93 of the application sheet 91 to the predetermined location of attachment on the surface 20 of the article 2, while peeling off and detaching the first inner release films 92 from the center, undesired substances such as dust or filth on the user's hands can become easily attached to the first adhesive layer 93 of the application sheet 91, which causes the undesired substance to become attached between the first adhesive layer 93 of the application sheet 91 and the surface 20 of the article 2, causing the application sheet 91 to fail to attach completely onto the surface 20 of the article 2. In addition, peeling off the first inner release films 92 from the center is not easy.

In view of this, a film assembly which is easy to attach to a surface of an article while preventing undesired substances from becoming attached between the film assembly and the surface of the article, which causes the film assembly to fail to attach completely onto the surface of the article, is something highly desired in this industry.

### SUMMARY OF THE INVENTION

The purpose of this invention is to provide a film assembly that can avoid having to be repeatedly peeled off and reapplied, while being easy to attach to the surface of an article. Also, it can prevent undesired substances from becoming attached between the film assembly and the surface of the article while attaching the film assembly to the surface of the article, allowing for complete attachment of the film assembly to the surface of the article.

To achieve the above objective, the film assembly of this invention comprises an application sheet and an inner release film. The inner release film comprises a first film portion, a second film portion and a pull portion. The application sheet has an outer surface and an inner surface. The inner surface of the application sheet is to be attached to the surface of the article. The first film portion of the inner release film covers the inner surface of the application sheet to prevent the inner surface of the application sheet from attaching to undesired substances and can be easily detached from the inner surface of the application sheet. The first film portion has a first edge. The second film portion is connected to and forms one piece with the first film portion at a connection edge and then folded under the first film portion. The pull portion is formed at the second film portion and protrudes out from the first edge of the first film portion.

The pull portion is to be pulled along a pull direction away from the connection edge while the second film portion contacts the surface of the article, so as to pull the second film portion in tandem, causing the first film portion to detach from, the inner surface of the application sheet, such that the inner surface of the application sheet is attached to the surface of the article without attracting undesired substances.

### BRIEF DESCRIPTION OF THE DRAWING

FIG. 1 is a schematic view of a conventional film assembly to be used to attach to a surface of an article;

FIG. 2A-2F are schematic views showing the steps for attaching another conventional film assembly to a surface of an article;

FIG. 3 is a schematic view of the film assembly in the first embodiment of this invention to be attached to a surface of an article;

FIG. 4 is a schematic view of the film assembly in the second embodiment of this invention to be attached to a surface of an article;

FIG. 5 is a schematic view of the film assembly in the third embodiment of this invention to be attached to a surface of an article;

FIG. 6 is a schematic view of an alignment pattern of the film assembly of this invention;

FIG. 7 is a schematic view showing that the first film portion and the second film portion of the inner release film are fixed together;

FIG. 8A-8D are schematic views showing the steps for attaching the film assembly in the first embodiment of this invention to a surface of an article;

FIG. 9A-9D are schematic views showing the steps for attaching the film assembly in the second embodiment of this invention to a surface of an article; and

FIG. 10A-10D are schematic views showing the steps for attaching the film assembly in the third embodiment of this invention to a surface of an article.

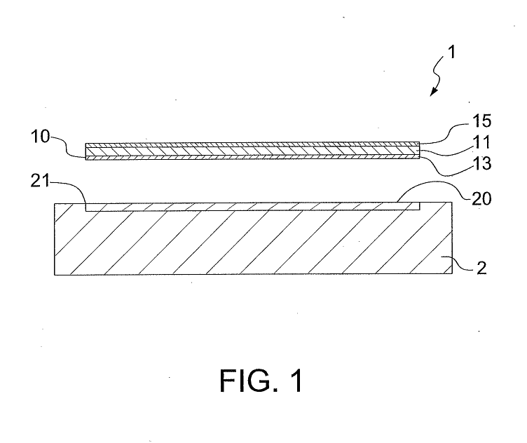

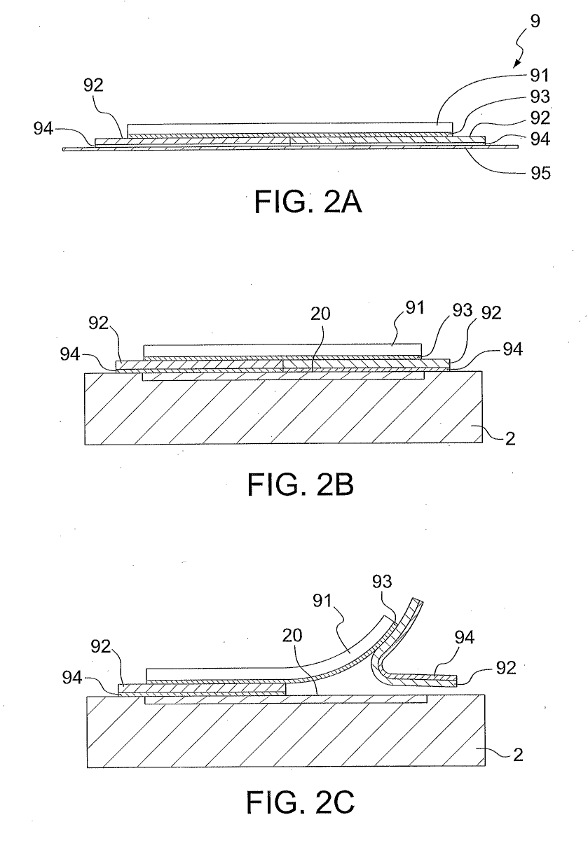

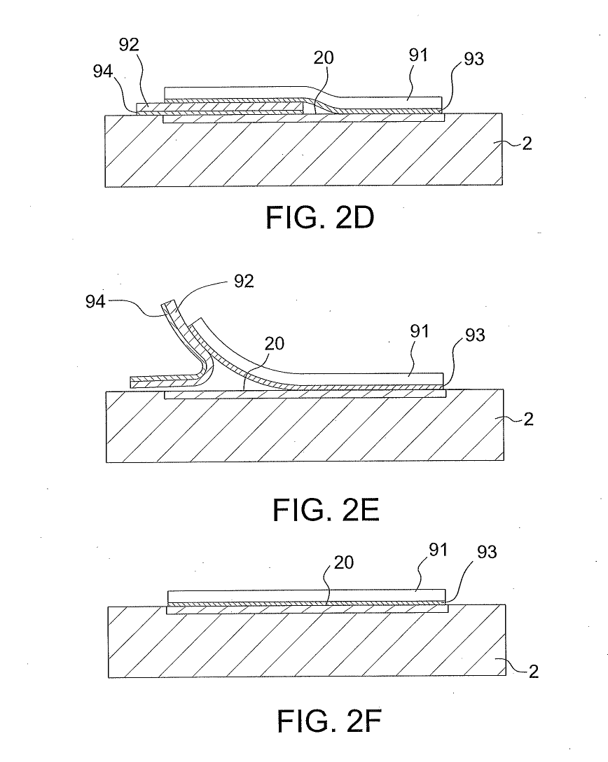

### DETAILED DESCRIPTION OF THE INVENTION

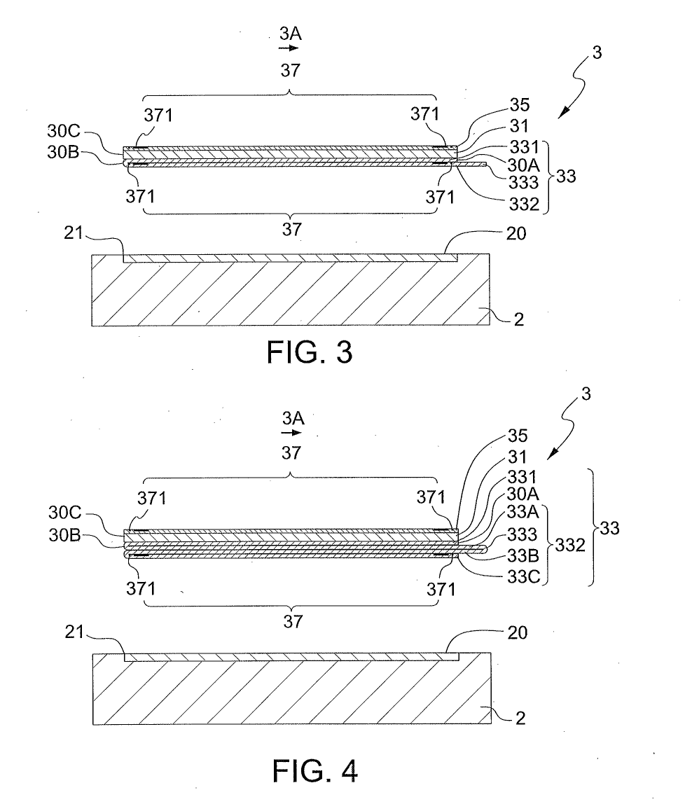

First of all, please refer to FIG. 3; the film assembly 3 of this invention to be attached to a surface 20 of an article 2 comprises at least an application sheet 31 and an inner release film 33. Among them, as mentioned above, the application sheet 31 of this invention can be protective films known to be attachable to the screens of various electronic devices or optical films with special optical properties etc., or thermal insulation films, anti-UV films etc. to be attached to car windows or house windows. In this embodiment, the article 2 is the surface of a television screen, a computer monitor, a mobile phone screen, a tablet screen, a camera screen, a multimedia device screen, a car window or a house window; and the application sheet 31 can be a protective film used to protect the surface 20 of the article 2; and the application sheet 31 can also be an electrostatic film or an adhesive film using static electricity or an adhesive layer to attach to the surface 20 of the article 2. During various bonding processes, the application sheet 31 of this invention can also be a hard substrate used for bonding to the surface 20 of the article 2.

The inner release film 33 in the first embodiment of this invention comprises a first film portion 331, a second film portion 332 and a pull portion 333, as shown in FIG. 3. The application sheet 31 has an outer surface and an inner surface. The inner surface of the application sheet 31 is to be attached to the surface 20 of the article 2. The first film portion 331 of the inner release film 33 covers the inner surface of the application sheet 31 to prevent the inner surface of the application sheet 31 from attracting undesired substances such as dust or filth on the user's hand before attaching the application sheet 31 to the surface 20 of the article 2. The first film portion 331 of the inner release film 33 is easily detached from the inner surface of the application sheet 31. The first film portion 331 has a first edge 30A. The second film portion 332 is connected to and forms one piece with the first film portion 331 at a connection edge 30B and is folded under the first film portion 331. The pull portion 333 of this invention is formed at the second film portion 332 and protrudes out from the first edge 30A of the first film portion 331. In the first embodiment of this invention, as shown in FIG. 3, an edge of the second film portion 332 extends and protrudes out from the first edge 30A of the first film portion 331 to form the pull portion 333.

The pull portion 333 is pulled along a pull direction 3A away from the connection edge 30B, while the second film portion 332 contacts the surface 20 of the article 2, to pull the second film portion 332 in tandem, causing the first film portion 331 to detach from the inner surface of the application sheet 31, such that the inner surface of the application sheet 31 attaches to the surface 20 of the article 2 without attracting undesired substances. Preferably, the pull portion 333 of the inner release film 33 of this invention is to be arranged towards the pull direction 3A at a location opposite the connection edge 30B of the second film portion 332.

Preferably, the second film portion 332 of the inner release film 33 is adhesive and can be an electrostatic film or an adhesive film, etc. In this case, when the second film portion 332 is attached to the surface 20 of the article 2, it can also adhere to undesired substances on the surface 20 of the article 2, such that the undesired substance on the surface 20 of the article 2 can be removed when the second film portion 332 is pulled by pulling the pull portion 333.

Preferably, please refer to FIG. 4 showing the second embodiment of this invention. In this embodiment, in order to more easily detach the inner release film 33 from the surface 20 of the article 2 and the inner surface of the application sheet 31 by pulling the pull portion 333, the second film portion 332 of the inner release film 33 comprises multiple layers of films. In this embodiment, the second film portion 332 comprises a first film body 33A, a second film body 33B and a third film body 33C. The first film portion 331 of the inner release film 33, the first film body 33A, the second film body 33B and the third film body 33C of the second film portion 332 are parallel with the pull direction 3A and are connected and folded in sequence to form the inner release film 33. A side of the first film body 33A and the second film body 33B of the second film portion 332 where the first film body 33A and said second film body 33B are connected, protrudes out from the first edge 30A of the first film portion 331 to form the pull portion 333. Similar to the first embodiment, the pull portion 333 formed from the first film body 33A and the second film body 33B of this invention is preferably arranged towards the pull direction 3A at the location of the second film portion 332 opposite the connection edge 30B.

In this embodiment, the third film body 33C of the second film portion 332 of the inner release film 33 is adhesive, such as an electrostatic film or an adhesive film. The first film body 33A and the second film body 33B are not necessarily adhesive. In this way, while the third film body 33C of the second film portion 332 is attached to the surface 20 of the article 2, it will simultaneously attract the undesired substances on the surface 20 of the article 2.

Please refer to FIG. 5 showing the third embodiment of this invention. Compared to FIG. 3 for the first embodiment, in which the pull portion 333 is formed by extending and protruding the second film portion 332 out from the first edge 30A of the first film portion 331, the pull portion 333 in the third embodiment of this invention is a pull film body that is formed between the first film portion 331 and the second film portion 332, extending from the connection edge 30B and protruding out from the first edge 30A of the first film portion 331. In the third embodiment, the second film portion 332 of the inner release film 33 of this invention is still preferably adhesive; thus, while the second film portion 332 is attached to the surface 20 of the article 2, it can simultaneously attract the undesired substances on the surface 20 of the article 2 so as to remove such undesired substances from the surface 20 of the article 2 while the second film portion 332 is pulled by pulling the pull portion 333.

Referring to FIGS. 3-5, the film assemblies 3 of this invention in each of the three embodiments all further comprise an outer release film 35. The outer release film 35 covers the outer surface of the application sheet 31 and can be easily detached from the outer surface of the application sheet 31. This prevents the outer surface of the application sheet 31 from attracting undesired substances before the application sheet 31 is attached to the surface 20 of the article 2.

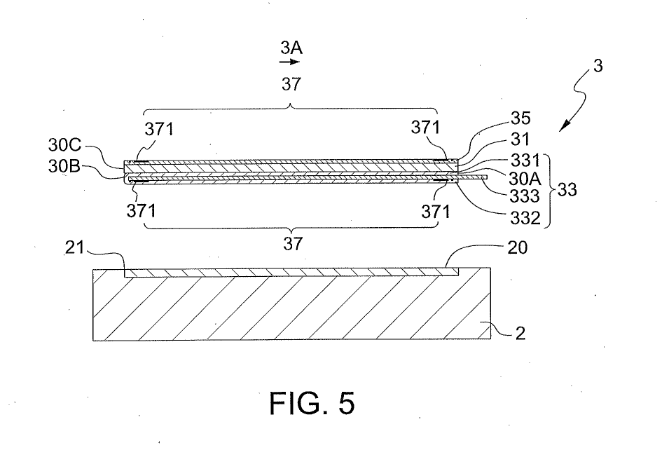

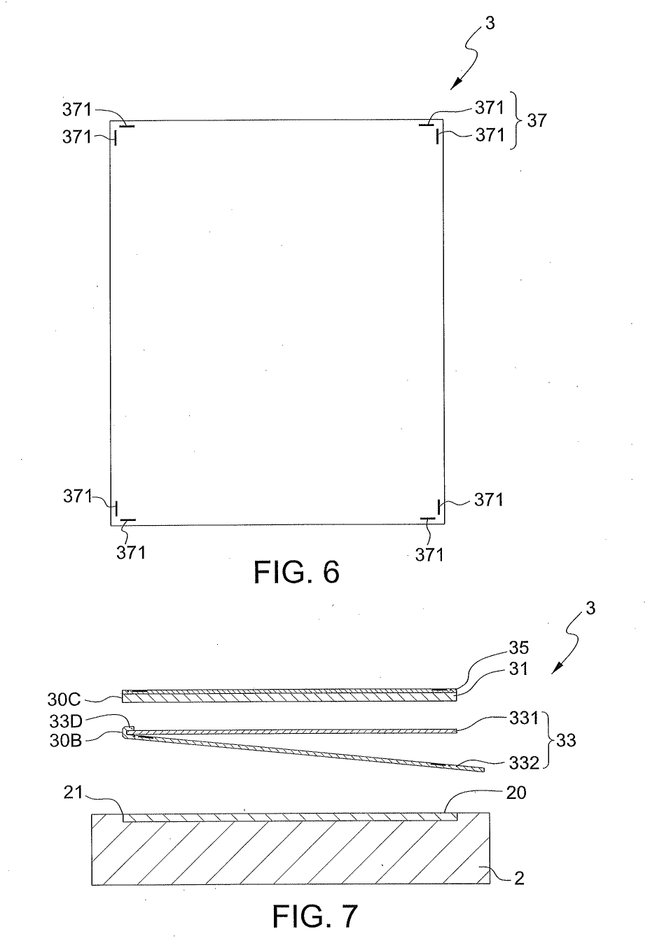

Referring to FIGS. 3-5, in order to increase the convenience of use for the users, the pull portion 333 of the film assembly 3 of this invention preferably has marks apparent for users to see. In addition, to facilitate the users in attaching the application sheet 31 of the film assembly 3 of this invention to an appropriate position on the surface 20 of the article 2, as shown in FIG. 6, the film assembly 3 is substantially rectangular and further contains at least an alignment pattern 37 which includes at least two pairs of lines 371. In this embodiment, there are four pairs of the lines 371, and these four pairs of the lines 371 are adjacent to four corners of the application sheet 31 respectively, extend along four edges of the application sheet 31, and are disposed on at least one of the outer release film 35 and the bottom of the second film portion 332 to help align a second edge 30C of the application sheet 31 with a predetermined alignment line 21 of the surface 20 of the article 2.

As shown in FIG. 4, the alignment pattern 37 disposed on the bottom of the second film portion 332 is disposed on the third film body 33C of the second film portion 332. In addition, as shown in FIGS. 3-5, the film assembly 3 of this invention can contain two alignment patterns 37, each containing four pairs of lines 371, with one alignment pattern 37 disposed on the outer release film 35 and the other alignment pattern 37 disposed on the bottom of the second film portion 332.

Regarding the inner release film 33 of the film assembly 3 of this invention, its second film portion 332 may form one piece with the first film portion 331 as shown in FIGS. 3-5, or it can be formed by fixing a connection part 33D of the second film portion 332 folded between the inner surface of the application sheet 31 and the first film portion 331 at the connection edge 30B with the first film portion 331, as shown in FIG. 7, using methods such as adhering or welding.

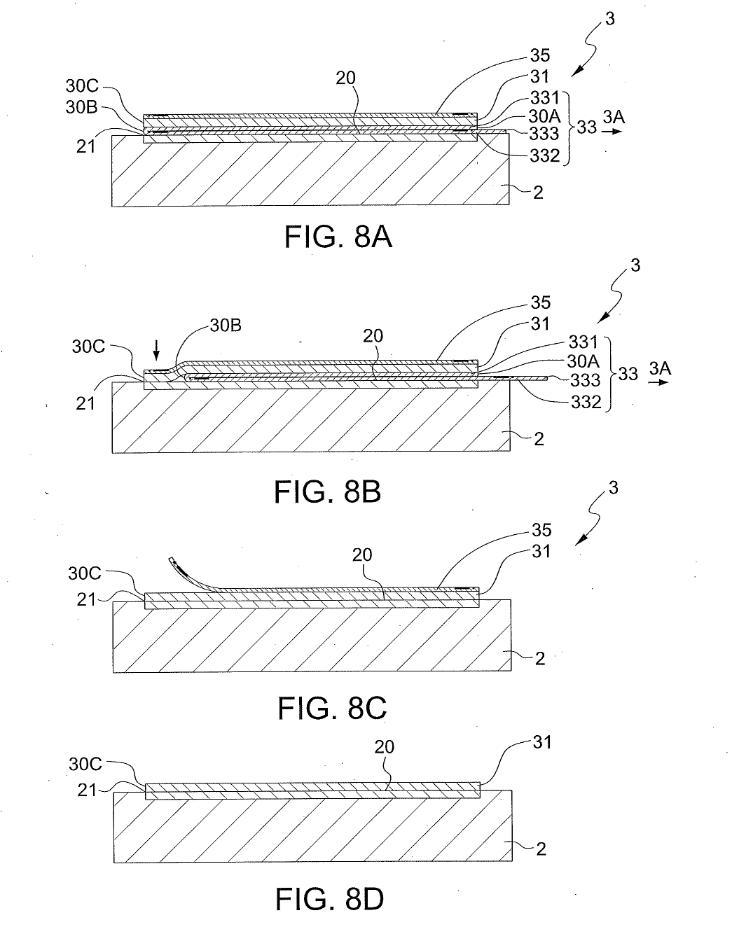

Please refer to FIG. 8A-8D, 9A-9D or 10A-10D, which illustrate the method for attaching the above described film assemblies 3 in the three embodiments of this invention to the surface 20 of the article 2. The methods for using the three embodiments of the film assemblies 3 of this invention (as shown in FIGS. 3-5 individually) described above are substantially identical. The shapes of the film assembly 3 in each step of the methods are different due to their structures being different. Therefore, the methods for use of the above-mentioned three embodiments will be described below together. The structures of the film assemblies 3 in the above-mentioned three embodiments will not be further discussed as they are previously described.

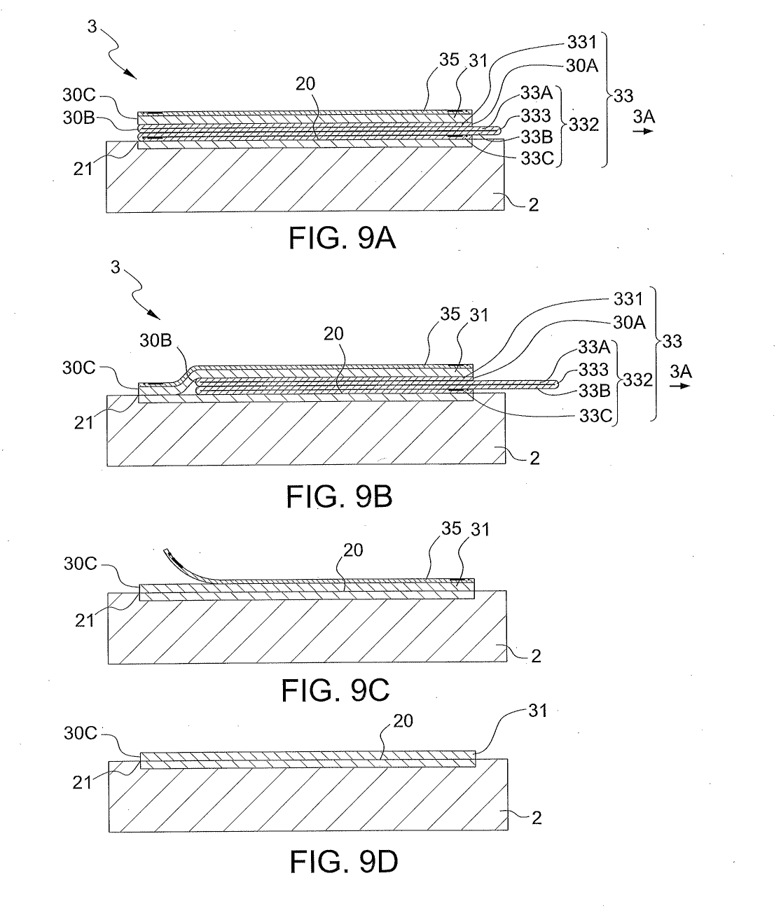

First of all, as shown in FIG. 8A, 9A or 10A, the film assembly 3 is placed on the surface 20 of the article 2 to contact the second film portion 332 with the surface 20 of the article 2. As shown in FIG. 9A, the film assembly 3 in the second embodiment in this step is in contact with the surface 20 of the article 2 through the third film body 33C of the second film portion 332.

Then, the second edge 30C of the application sheet 31 is aligned with a predetermined alignment line 21 on the surface 20 of the article 2. As shown in FIG. 8A, 9A or 10A, the second edge 30C of the application sheet 31 chosen by the user to be aligned with the predetermined alignment line 21 on the surface 20 of the article 2 can overlap the connection edge 30B where the first film portion 331 and the second film portion 332 are connected (as shown in FIGS. 3-5); that is, the user can choose the connection edge 30B in advance to align it with the corresponding predetermined alignment line 21. However, the user can also choose other edges of the application sheet 31 to align with the second edge 30C.

As described above, at least one alignment pattern 37 of the film assembly 3 can help the user to more easily align the film assembly 3 with the predetermined alignment line 21. As shown in FIG. 6, the above-mentioned alignment pattern 37 comprises four pairs of lines 371. The four pairs of lines 371 are adjacent to the four corners of the application sheet 31 respectively, extend along the four edges of the application sheet 31, and are disposed on at least one of the outer release film 35 and the bottom of the second film portion 332.

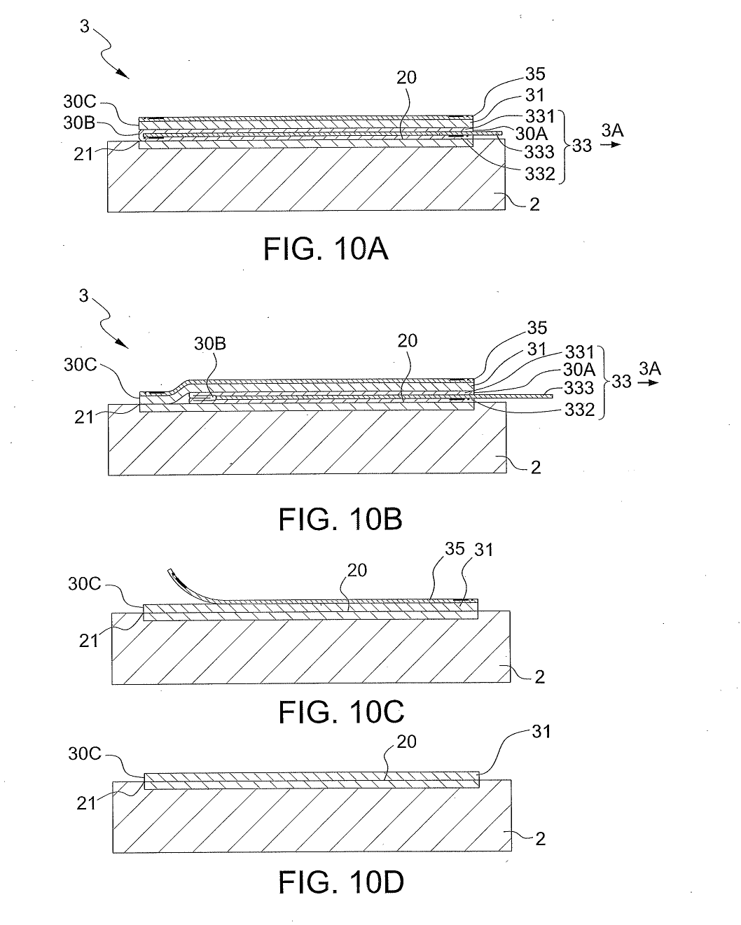

Then, as shown in FIG. 8B-8C, 9B-9C or 10B-10C, by pulling the pull portion 333 formed at the second film portion 332 along the pull direction 3A away from the connection edge 30C to pull the second film portion 332, in tandem with detaching the first film portion 331 from the inner surface of the application sheet 31, the inner surface of the application sheet 31 is attached to the surface 20 of the article 2 without attracting undesired substances. As shown in FIGS. 8B-8C, in the film assembly 3 in the first embodiment of this invention, in this step, the pull portion 333 that is formed by the edge of the second film portion 332 extending and protruding out from the first edge 30A of the first film portion 331 is pulled. As shown in FIGS. 9B-9C, in the film assembly 3 in the second embodiment of this invention, the pull portion 333 that is formed by a side of the first film body 33A and the second film body 33B where the first film body 33A and the second film body 33B are connected, protruding out from the first edge 30A of the first film portion 331, is pulled. As shown in FIGS. 10B-10C, in the film assembly 3 in the third embodiment of this invention, in this step, the pull film body of the pull portion 333 that is formed between the first film portion 331 and the second film portion 332 extending from the connection edge 30B and protruding out from the first edge 30A of the first film portion 331 is pulled.

In detail, the above mentioned step of pulling the second film portion 332 in tandem with detaching the first film portion 331 from the inner surface of the application sheet 31 can comprise the following steps. As shown in FIG. 8B, 9B or 10B, the pull portion 333 pulls out the second film portion 332 in tandem and at the same time detaches a portion of the first film portion 331 from the inner surface of the application sheet 31 so as to expose a portion of the inner surface of the application sheet 31. Immediately following or at the same time, a pressure is applied toward the exposed portion of the inner surface of the application sheet 31 on the surface 20 of the article 2, which causes said exposed portion of the inner surface of the application sheet 31 to attach to the surface 20 of the article 2 in a roughly fixed relative position between the application sheet 31 and the surface 20 of the article 2. Later, the pull portion 333 is continuously pulled to pull the second film portion 332 in tandem, causing the first film portion 331 to be completely detached from the inner surface of the application sheet 31, and at the same time, a pressure is applied toward the application sheet 31 on the surface 20 of the article 2, such that the inner surface of the application sheet 31 is completely attached to the surface 20 of the article 2 without attracting undesired substances, as shown in FIG. 8C, 9C or 10C.

If the application sheet 31 of this invention is a hard substrate that is used during various bonding processes for attaching to the surface 20 of the article 2, the application sheet 31 is less susceptible to deformation. In this case, the above mentioned exposed portion of the inner surface of the application sheet 31 may not be completely attached to the surface 20 of the article 2, as shown in FIG. 8B, 9B or 10B.

After the above mentioned steps, the outer release film 35 is detached from the outer surface of the application sheet 31 to complete the attachment process for the application sheet 31 of the film assembly 3 of this invention, as shown in FIG. 8C-8D, 9C-9D or 10C-10D.

Please refer to FIG. 8A-8C or 10A-10C, as described above, which show that the second film portion 332 can be adhesive so that while the second film portion 332 is attached to the surface 20 of the article 2, it simultaneously attracts undesired substances located on the surface 20 of the article 2; as a result, while pulling the pull portion 333 to pull the second film portion 332, undesired substances on the surface 20 of the article 2 will be removed simultaneously.

Please refer to FIGS. 9A-9C, which show that under the circumstance that the second film portion 332 of the inner release film 33 in the above second embodiment described above includes the first film body 33A, the second film body 33B and the third film body 33C, the third film body 33C of the second film portion 332 can be adhesive so that while the third film body 33C of the second film portion 332 is attached to the surface 20 of the article 2, it simultaneously attracts undesired substances on the surface 20 of the article 2 at the same time.

As described above, the above method can attach the film assembly 3 of this invention to the surface 20 of an article 2, such as one of a television screen, a computer monitor, a mobile phone screen, a tablet screen, a camera screen, a multimedia device screen, a car window or a household window.

In this way, the film assembly 3 of this invention can avoid having to repeatedly peel off and attach the application sheet 31, and thus enable easy attachment of the application sheet 31 to the surface 20 of the article 2. Furthermore, while attaching the application sheet 31 to the surface 20 of the article 2, said film assembly 3 can prevent undesired substance from becoming attached between the application sheet 31 and the surface 20 of the article 2, which would cause the application sheet 31 to fail to be completely attached to the article 2 surface 20.

What is claimed is:

1. A film assembly for attachment to a surface of an article, comprising:
an application sheet having an outer surface and an inner surface, wherein said inner surface of said application sheet is to be attached to said surface of said article; and
an inner release film, wherein said inner release film comprises:
a first film portion covering said inner surface of said application sheet to prevent said inner surface of said application sheet from attracting undesired substances while being easy to detach from said inner surface of said application sheet, wherein said first film portion has a first edge; and
a second film portion connected to and forming one piece with said first film portion at a connection edge and folded under said first film portion;
a pull portion formed at said second film portion and protruding out from said first edge of said first film portion, wherein said pull portion is pulled along a pull direction away from said connection edge while said second film portion contacts said surface of said article to pull said second film portion in tandem, causing said first film portion to detach from said inner surface of said application sheet, such that said inner surface of said application sheet is attached to said surface of said article without attaching said undesired substance.

2. The film assembly as described in claim 1, wherein said second film portion is adhesive, and while said second film portion is attached to said surface of said article, it simultaneously attracts said undesired substances on said surface of said article so as to remove said undesired substances on said surface of said article when said second film portion is pulled by pulling said pull portion.

3. The film assembly as described in claim 1, wherein an edge of said second film portion extends and protrudes out from said first edge of said first film portion to form said pull portion.

4. The film assembly described as in claim 1, wherein said second film portion comprises a first film body, a second film body and a third film body; and said first film portion, said first film body, said second film body and said third film body are parallel with said pull direction and are connected and folded in sequence to form said inner release film, and a side of said first film body and said second film body where said first film body and said second film body are connected protrudes out from said first edge of said first film portion to form said pull portion.

5. The film assembly as described in claim 4, wherein said third film body of said second film portion is adhesive, and said third film body of said second film portion while being attached to said surface of said article simultaneously attracts said undesired substances on said surface of said article.

6. The film assembly as described in claim 1, wherein said pull portion between said first film portion and said second film portion extends from said connection edge and protrudes out from said first edge of said first film portion to form a pull film body.

7. The film assembly as described in claim 2, wherein said second film portion of said inner release film is an electrostatic film or an adhesive film.

8. The film assembly as described in claim 5, wherein said third film body of said second film portion of said inner release film is an electrostatic film or an adhesive film.

9. The film assembly as described in claim 1, wherein said film assembly further comprises an outer release film that covers said outer surface of said application sheet and can be easily detached from said outer surface of said application sheet to prevent said outer surface of said application sheet from attracting said undesired substances.

10. The film assembly according to claim 9, wherein said film assembly is substantially rectangular and further comprises at least one alignment pattern, wherein said alignment pattern comprises at least two pairs of lines adjacent to at least two corresponding corners of said application sheet respectively, extending along corresponding edges of said application sheet and disposed on at least one of said outer release film and a bottom of said second film portion to help align a second edge of said application sheet with a predetermined alignment line of said surface of said article.

11. The film assembly as described in claim 1, wherein said second film portion forms one piece with said first film portion, or a connective part of said second film portion is folded between said inner surface of said application sheet and said first film portion and is fixed with said first film portion.

12. The film assembly as described in claim 1, wherein said application sheet is a protective film used to protect said surface of said article or a hard substrate used for bonding with said surface of said article.

13. The film assembly as described in claim 1, wherein said application sheet is an electrostatic film or an adhesive film.

14. The film assembly as described in claim 1, wherein said surface of said article is a television screen, a computer monitor, a mobile phone screen, a tablet screen, a camera screen, a multimedia device screen, a car window or a house window.

15. A method for attaching a film assembly to a surface of an article, wherein said film assembly comprises an application sheet having an outer surface, an inner surface and an inner release film; wherein said inner release film comprises a first film portion, a second film portion and a pull portion; wherein said first film portion covers said inner surface of said application sheet and has a first edge; said second film portion is connected to and forms one piece with said first film portion and is folded under said first film portion; and said pull portion is formed at said second film portion and protrudes out from said first edge of said first film portion; while comprising the following steps:
(a) placing said film assembly on said surface of said article to bring said second film portion into contact with said surface of said article; and
(b) pulling said pull portion along a pull direction away from said connection edge to pull said second film portion in tandem, causing said first film portion to become easy to detach from said inner surface of said application sheet, so as to attach said inner surface of said application sheet to said surface of said article without attracting undesired substances.

16. The method according to claim 15, wherein said second film portion is adhesive, such that in said step (a), while said second film portion is being attached to said surface of said article, said undesired substances on said surface of said article are simultaneously attracted, and in said step (b), while said pull portion is pulled to pull said second film portion, said undesired substances on said surface of said article are removed.

17. The method according to claim 15, wherein an edge of said second film portion extends and protrudes out from said first edge of said first film portion to form said pull portion, and said step (b), wherein said pull portion formed by the extension from pulling said edge of said second film portion is pulled.

18. The method according to claim 15, wherein said second film portion comprises a first film body, a second film body and a third film body, and said first film portion, said first film body, said second film body and said third film body are parallel with said pull direction and are connected and folded in sequence to form said inner release film, and said step (b), wherein said pull portion formed from a side of said first film body and said second film body where said first film body and said second film body are connected, protruding out from said first edge of said first film portion is pulled.

19. The method according to claim 18, wherein said third film body of said second film portion is adhesive, and in said step (a) while said third film body of said second film portion is being attached to said surface of said article, said undesired substances on said surface of said article are simultaneously attracted.

20. The method according to claim 15, wherein said pull portion between said first film portion and said second film portion extends from said connection edge and protrudes out from said first edge of said first film portion to form a pull film body, and said step (b), wherein said pull film body of said pull portion is pulled.

21. The method according to claim 15, wherein said step (b) further comprises the following steps of:
(b-1) pulling said pull portion to pull said second film portion in tandem, allowing a portion of said first film portion to detach from said inner surface of said application sheet to expose a portion of said inner surface of said application sheet; and
(b-2) applying pressure toward said surface of said article and said exposed portion of said inner surface of said application sheet to attach said exposed portion of said inner surface of said application sheet to said surface of said article; and
(b-3) continuing pulling said pull portion to pull said second film portion in tandem, causing said first film portion to completely detach from said inner surface of said application sheet, while applying pressure toward said surface of said article and said application sheet at the same time to completely attach said inner surface of said application sheet to said surface of said article without attracting said undesired substances.

22. The method according to claim 21, wherein said method further comprises the following step after said step (a) but before said step (b):
(a-1) aligning a second edge of said application sheet to a predetermined alignment line of said surface of said article.

23. The method according to claim 22, wherein said film assembly further comprises an outer release film covering said outer surface of said application sheet and is easy to detach from said outer surface of said application sheet, which prevents said outer surface of said application sheet from attracting said undesired substances, wherein said method further comprises the following step after said step (b):
(c) detaching said outer release film from said outer surface of said application sheet.

24. The method according to claim 23, wherein said film assembly is substantially rectangular and further comprises at least one alignment pattern, wherein said alignment pattern comprises at least two pairs of lines adjacent to at least two corresponding corners of said application sheet respectively, which extend along corresponding edges of said application sheet and are disposed on at least one of said outer release film and a bottom of said second film portion to facilitate said step (a-1).

25. The method according to claim 22, wherein said second edge of said application sheet overlaps said connection edge.

26. The method according to claim 15, wherein said surface of said article is a television screen, a computer monitor, a mobile phone screen, a tablet screen, a camera screen, a multimedia device screen, a car window or a house window.
